(19) United States
(12) Patent Application Publication
(10) Pub. No.: US 2026/0193971 A1
(43) Pub. Date: Jul. 9, 2026

(54) SYSTEMS AND METHODS FOR PRODUCING CARBON-FREE HYDROGEN

(71) Applicant: Saudi Arabian Oil Company, Dhahran (SA)

(72) Inventors: Serguey Viktorov Arkadakskiy, Edmonton (CA); Simon A. Stewart, Dhahran (SA)

(21) Appl. No.: 19/009,330

(22) Filed: Jan. 3, 2025

(51) Int. Cl. E21B 43/295; C01B 3/08; C10G 29/04

(52) U.S. Cl. CPC E21B 43/295; C01B 3/08; C10G 29/04; C01B 2203/063; C10G 2300/1033; C10G 2300/207

(57) ABSTRACT

Provided herein are methods and systems for producing carbon-free hydrogen. The method includes introducing a hydrogen sulfide (H₂S)-bearing fluid stream into an iron-rich subsurface reservoir predominantly containing one or more types of reactive ferric iron-rich minerals, and contacting the H₂S-bearing fluid stream with the one or more types of reactive ferric iron-rich minerals present in the iron-rich subsurface reservoir, thereby generating a sweet fluid stream having a reduced-sulfur content as compared to the H₂S-bearing fluid stream and an iron scale deposited within the iron-rich subsurface reservoir and forming a hydrogen gas cap in an upper portion of the iron-rich subsurface reservoir beneath a cap rock seal.

### TECHNICAL FIELD

The present disclosure relates to methods and systems for producing carbon-free hydrogen, more particularly, to methods and systems for permanent disposal of a hydrogen sulfide (H₂S) bearing fluid stream into ferric iron-rich geological formations and simultaneously generating hydrogen gas (H₂).

### BACKGROUND

Hydrogen sulfide (H₂S), also known as “sour” gas, is a common sulfur waste-gas, which is highly poisonous and corrosive. H₂S is naturally generated in oxygen-deficient environments such as hydrocarbon reservoirs, euxinic freshwater or marine basins, and active volcanic areas, typically through the organic (biogenic) and/or inorganic or microbial reduction of oxidized sulfur species. For example, large amounts of H₂S can form from the organic (biogenic) and/or inorganic (thermochemical) reduction of sulfate (SO₄) in subsurface hydrocarbon reservoirs. These reactions are often coupled with the oxidation of hydrocarbons, which produces significant amounts of CO₂ with a mixture of H₂S and CO₂ produced in the subsurface reservoir referred to as “acid” gas. The presence of significant amounts of sour (H₂S) and/or acid gas in petroleum reservoirs subjected to bacterial sulfate reduction (BSR) and/or thermochemical sulfate reduction (TSR), presents significant technical and/or operational challenges, which may render such reservoirs uneconomic in the absence of safe and cost-effective treatment/removal methods.

SO₂ is a waste gas generated during the combustion of H₂S-bearing fossil fuels, among other combustion products. SO₂ is often present as a contaminant in flue gases emitted from industrial facilities as well as in the CO₂ separated from those gases for utilization or disposal.

The presence of H₂S, CO₂ and/or SO₂ in value (e.g., hydrocarbons) or waste (e.g., flue gas) streams typically requires expensive treatments, which incur significant capital and operating costs. Therefore, cost-effective and environmentally acceptable methods for the removal and safe disposal of H₂S, CO₂, SO₂ and/or mixtures thereof are needed.

Hydrogen is a high-energy, dense fuel that offers a viable carbon-free alternative to hydrocarbon fuels across nearly all industrial and transportation sectors. However, over 95% of today's hydrogen is produced via steam reforming of natural gas, oil, and coal-a highly energy-intensive and polluting process that releases between 7 and 12 tons of CO₂ for every ton of hydrogen produced. Consequently, there is a need for cost-effective and sustainable methods and systems to produce carbon-free hydrogen gas, addressing H₂S as well as CO₂ and/or SO₂ management and hydrogen production challenges.

### SUMMARY

In an exemplary embodiment, a method for producing carbon-free hydrogen includes introducing a hydrogen sulfide (H₂S)-bearing fluid stream into a geological formation containing an iron-rich subsurface reservoir and a cap rock seal. In some embodiments, the iron-rich subsurface reservoir predominantly contains one or more types of reactive ferric iron-rich minerals. The reservoir may contain ferric iron bearing minerals and ferrous iron bearing minerals. The method also includes contacting the H₂S-bearing fluid stream with the one or more types of reactive ferric iron-rich minerals present in the iron-rich subsurface reservoir, thereby generating a sweet fluid stream having a reduced-sulfur content as compared to the H₂S-bearing fluid stream and an iron scale deposited within the iron-rich subsurface reservoir and forming a hydrogen gas cap in an upper portion of the iron-rich subsurface reservoir beneath the cap rock seal. The method further includes flowing the sweet fluid stream into a sweet fluid storage unit via a sweet fluid production well, and flowing the hydrogen gas cap into a hydrogen storage unit via a hydrogen production well.

In some embodiments, the one or more types of reactive ferric iron-rich minerals are in the form of a crystalline phase and/or an amorphous phase.

In some embodiments, the one or more types of reactive ferric iron-rich minerals are selected from the group consisting of ferric oxide, hematite, magnetite, goethite, limonite, maghemite, ferric hydroxide, ferroxyhyte, ferrihydrite, akaganeite, lepidocrocite, schwertmannite, green rust, fougerite, biotite, hornblende, jarosite, glauconite, and iron chlorite.

In some embodiments, the H₂S-bearing fluid stream further contains one or more components selected from the group consisting of carbon dioxide (CO₂), sulfur dioxide (SO₂) water, brine, one or more hydrocarbons, and one or more additives.

In some embodiments, the H₂S-bearing fluid stream is in liquid, gas, or supercritical fluid form.

In some embodiments, the H₂S-bearing fluid stream comprises one or more of CO₂ and/or SO₂, and the iron scale contains at least one of an iron sulfide scale or an iron carbonate scale.

In some embodiments, the H₂S-bearing fluid stream is formed by introducing H₂S into a supercritical CO₂ stream before the introducing the H₂S-bearing fluid stream into the iron-rich subsurface reservoir.

In some embodiments, the iron sulfide scale contains at least one of pyrite, marcasite pyrrhotite, troilite, greigite, mackinawite, or marcasite.

In some embodiments, the iron sulfide scale contains pyrite.

In some embodiments, the iron carbonate scale contains at least one of siderite or ankerite.

In some embodiments, the iron carbonate scale contains siderite.

In some embodiments, the iron-rich subsurface reservoir is in fluid communication with a H₂S-bearing fluid storage unit via a crossflow well.

In some embodiments, the iron-rich subsurface reservoir is in fluid communication with a water source via a water injection well.

In some embodiments, the iron-rich subsurface reservoir is in a geometric structure selected from the group consisting of a horizontal structure, an inclined structure, a planar structure, a folded structure, and a faulted structure.

In some embodiments, the iron-rich subsurface reservoir is a porous reservoir that can hold the H₂S-bearing fluid stream within its pores and cavities, thereby preventing the H₂S-bearing fluid stream flowing into surrounding geological formations.

In an exemplary embodiment, the method for producing carbon-free hydrogen further includes monitoring a concentration of the iron sulfide scale in the iron-rich subsurface reservoir; and in response to the concentration of the iron sulfide scale exceeding a threshold concentration, stopping the introduction of the H₂S-bearing fluid stream from a H₂S-bearing fluid storage unit into the iron-rich subsurface reservoir.

In some embodiments, the concentration of the iron sulfide scale present in the filtration reservoir is obtained by a surface-based remote sensing technique selected from the group consisting of a four-dimensional (4D) reflection seismic survey technique, a gravity survey technique, a magnetic survey technique, and a magnetotellurics survey technique.

In some embodiments, the H₂S-bearing fluid storage unit is a subsurface reservoir and is in fluid communication with the iron-rich subsurface reservoir via a crossflow well.

In some embodiments, the iron scale contains pyrite and siderite.

In an exemplary embodiment, a system for producing carbon-free hydrogen includes a sour fluid injection well configured to flow a H₂S-bearing fluid stream into the system; a geological formation containing an iron-rich subsurface reservoir and a cap rock seal. In some embodiments, the iron-rich subsurface reservoir predominantly contains one or more types of reactive ferric iron-rich minerals that are capable of reacting the H₂S-bearing fluid stream with the one or more types of reactive ferric iron-rich minerals to generate a sweet fluid stream having a reduced-sulfur content as compared to the H₂S-bearing fluid stream, an iron scale deposited within the iron-rich subsurface reservoir, and a hydrogen gas cap in an upper portion of the iron-rich subsurface reservoir beneath the cap rock seal. The system further includes a sweet fluid production well configured to flow the sweet fluid stream; a hydrogen production well configured to flow the hydrogen gas cap; a water injection well configured to flow water into the iron-rich subsurface reservoir, thereby supporting fluid movement within the iron-rich subsurface reservoir; and a surface-based remote sensing sensor configured to measure and monitor a concentration of the iron scale in the iron-rich subsurface reservoir.

In an exemplary embodiment, the system for producing carbon-free hydrogen further includes a sweet fluid storage unit in fluid communication with the iron-rich subsurface reservoir via the sweet fluid production well; a hydrogen storage unit in fluid communication with the iron-rich subsurface reservoir via the hydrogen production well; a H₂S-bearing fluid storage unit in fluid communication with the iron-rich subsurface reservoir via the sour fluid injection well; and a water source in fluid communication with the iron-rich subsurface reservoir via the water injection well.

### BRIEF DESCRIPTION OF THE DRAWINGS

FIG. 1 is a schematic diagram depicting a system (100) for producing carbon-free hydrogen in a subsurface geological formation, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “substantially” refers to a majority of, or mostly, as in at least about 50%, such as about 60%, about 70%, about 80%, about 90%, about 95%, about 96%, about 97%, about 98%, about 99%, about 99.5%, about 99.9%, about 99.99%, or at least about 99.999% or more.

As used herein, the term “predominantly” means more than about 50%, such as at least about 60%, at least about 70%, at least about 80%, at least about 90%, at least about 95%, at least about 99%, or at least about 99.99% of the specified component meets the specified conditions.

As used herein, the term “rock” refers to naturally occurring solid minerals, collections of minerals, organic matter and/or natural petroleum substances. The collection of rocks is referred to as a “rock formation.” Types of rocks include sedimentary rock, igneous rock, metamorphic rock, and combinations thereof.

As used herein, the term “geological formation” refers to a body of rock that is sufficiently distinctive and continuous that it can be mapped as distinct entity. The geological formation can include a rock formation, a rock reservoir, a reactive rock formation, a reactive rock reservoir, water-containing formation, or deep aquifer, hydrocarbon-containing formation, or hydrocarbon reservoir, among others.

As used herein, the term “subsurface formation” refers to a geological formation located beneath the surface of the earth. A subsurface formation is sufficiently homogenous to form a single, identifiable unit/units containing similar properties throughout the subsurface formation, including, but not limited to, porosity and permeability.

As used herein, “impermeable” means a permeability of zero or of very low permeability, such as in the range of nano Darcys. “Darcy” as used herein, refers to the unit for permeability of a medium under Darcy's Law. For example, with the exception of volcanic rocks such as basalt, most reactive igneous and metamorphic rocks lack primary porosity and may therefore be considered impermeable, unless fractured naturally due to tectonic stresses. Examples of impermeable or low permeability sedimentary rocks include fine-grained clastic sedimentary rocks such as shale and siltstone, which may act as reservoir seals. In contrast, most coarse-grained clastic sedimentary rocks such as sandstone and conglomerate possess significant primary porosity and therefore permeability. However, clastic sedimentary rocks such as sandstone, etc., the pores of which have been filled by secondary minerals may also lose most if not all of their permeability and could therefore become “impermeable”.

As used herein, reactive rock is a rock comprised of minerals that can react with components of an injected fluid stream to precipitate and store components of the injected stream in a subsurface reactive rock formation. Reactive rocks may include, for example, sedimentary, igneous and metamorphic rocks that contain iron-rich minerals capable of reacting with sulfur and carbon species to produce stable secondary sulfide and carbonate phases.

Examples of reactive sedimentary rocks include iron-bearing clastic sedimentary rocks such as shale, claystone, siltstone, sandstone, conglomerate, and chemical sedimentary rocks such as the banded iron formations (BIF). Iron-rich sedimentary formations contain significant amounts of predominantly ferric iron-rich reactive minerals (and amorphous phases) including but not limited to hematite, magnetite, goethite, ferrihydrite, lepidocrocite, etc., capable of rapidly reacting with H₂S and/or CO₂. Iron-rich sedimentary rocks have a widespread global distribution as these are an integral part of most sedimentary basins. Iron-rich sediments such as sandstones and conglomerates have high to very high primary porosities and permeabilities. In some examples, a reactive subsurface reservoir comprises a (ferric) iron-rich sandstone within a sedimentary basin.

Reactive igneous and metamorphic rocks comprise predominantly of iron and magnesium rich silicate minerals, also known as mafic minerals, and are therefore referred to as mafic or ultramafic rocks. Mafic minerals can be dark in color, and examples of mafic rock-forming minerals include, but are not limited to, olivine, pyroxene, amphibole, and biotite. Chemically, the mafic and ultramafic igneous and metamorphic rocks can be enriched in iron, magnesium, and calcium. Examples of mafic rocks include basalt, diabase, and gabbro. Examples of ultramafic rocks include dunnite, peridotite and pyroxenite. Examples of mafic metamorphic rocks include melanocratic schist, gneiss, and eclogite. The mafic minerals in mafic and ultramafic igneous and metamorphic rocks contain predominantly reduced ferrous iron or Fe²⁺. Some igneous and metamorphic rocks also contain rock forming minerals such as amphibole, biotite, chlorite, etc., which may contain significant ferric iron (Fe³⁺). With the exception of the volcanic (extrusive) rocks such as basalt, the reactive igneous and metamorphic rocks lack primary porosity and permeability unless fractured.

As used herein, the terms “wellbore” or “well” refer to a hole drilled into the earth extending from the surface down to a subterranean formation capable of accessing a reservoir of oil, gas, water, or other subsurface resources. The wellbore of the present disclosure includes, but is not limited to, a bored well, a production well, a reservoir-crossflow well, an injection well, a water source well, a relief well, and an exploration well. Additionally, the wellbore can be vertical, horizontal, or positioned at any angle within the formation. A wellbore forms a pathway capable of permitting both fluids and apparatus to traverse between the surface and the formation or to crossflow between geological formations without lifting fluids to the ground. Besides defining the void volume of the wellbore, the wellbore wall also acts as the interface through which fluid can transition between the subterranean formation and the interior of the wellbore. The wellbore wall can be unlined (that is, bare rock or formation) to permit such interaction with the formation, or lined, such as by a tubular string, casing, tubing, or liners, so as to prevent or restrict such interactions. In cases where the wellbore is lined, perforations can be made at specific depths of the wellbore to allow controlled access to subsurface resources of interest. Additionally, the wellbore may include completion equipment installed inside the tubing, such as valves and other control systems, to manage and regulate fluid movement between the reservoir and the wellbore. As used throughout this disclosure, the term “fluid” can include liquids, gases, or both.

As used herein, the term “formation crossflow well” and “crossflow well” refer to a channel that fluidly connects the two adjacent rock formations, e.g., a storage reservoir and an iron-rich subsurface reservoir. A crossflow well can be in fluid communication with reactive iron-rich minerals in the iron-rich subsurface reservoir and be configured to allow fluids, such as a mixture of one or more gases, an aqueous solution of one or more dissolved gases, a hydrocarbon solution of one or more dissolved gases, and combinations thereof, to be delivered to react with the one or more types of reactive iron-rich minerals in the iron-rich subsurface reservoir.

As used herein, the terms “downhole” or “uphole” refer to a position within a wellbore relative to the surface, with uphole indicating direction or position closer to the surface and downhole referring to direction or position farther away from the surface.

As used herein, the term “brine” refers to a natural or man-made aqueous solution that contains predominantly the dissolved chloride salts of one or more monovalent or divalent metals. In this disclosure, “brine” can refer to any aqueous solution that contains soluble salts such as NaCl, KCl, CaCl₂, MgCl₂, and/or any other water-soluble compounds, or mixtures thereof having a total dissolved solids (TDS) of about 35,000 parts per million (ppm) to about 400,000 ppm. The term “brine” can refer to any naturally derived saline solution, for example, seawater or salt lake water, the salt content of which may originate from the dissolution of salts (evaporites) or be of residual evaporitic origin, or it can refer to subsurface salt solutions such as sedimentary basin brine, the salt content of which is of the same origin as surface brines but may be further modified by water-rock reactions. Brine can be used in its natural state or after having undergone processing, such as filtration and/or chemical treatment to remove contaminants and large particles, or may be entirely of synthetic (anthropogenic/engineered) origin as a product or a by-product of various industrial process/processes.

As used herein the term “fluid stream” refers to a stream comprised of gaseous, supercritical and liquid aqueous and/or non-aqueous fluid/fluids or mixtures thereof with or without one or more additives. The fluid stream may comprise entirely or in part of H₂S, CO₂, and/or SO₂, and/or a mixture thereof with aqueous and/or non-aqueous components. The aqueous component could comprise of natural water or brine including but not limited to surface water such as river, lake and seawater/brine, subsurface water such as groundwater and formation water/brine as well as of treated or man-made aqueous fluids including but not limited to industrial water, wastewater, water of condensation, brine, etc. The non-aqueous components may include but not be limited to natural or synthetic gaseous or liquid hydrocarbons and/or chemicals soluble in those liquid hydrocarbons.

H₂S, CO₂, and/or SO₂ may originate entirely or in part from natural or industrial sources, including but not limited to “sour” hydrocarbon treatment and refining facilities, chemical plants, power generation plants, wastewater treatment plants, etc. H₂S, CO₂, and/or SO₂ may be originally present in individual or plural fluid components of the fluid stream or may be added to the fluid stream and/or individual components thereof at any step before a fluid stream is injected into the subsurface. In some embodiments H₂S, and/or CO₂, and/or SO₂ can be added to a fluid stream during injection in the subsurface by mixing those with fluid stream components inside the wellbore of an injection well. In some embodiments, components of the fluid stream may be of commercial value (e.g., hydrocarbons) and hence these may be recovered from the subsurface reservoir after the mineralization of H₂S, SO₂, and/or CO₂.

As used herein, the term “carbon-free hydrogen” refers to hydrogen that is produced without emitting carbon dioxide (CO₂) or other greenhouse gases during the production process. Additionally, the process to generate carbon-free hydrogen should not require steam reforming of hydrocarbons, water electrolysis, radiolysis, thermolysis and/or any other engineering process to be conducted in a surface facility. In the present disclosure, a H₂S-bearing stream is injected into a predominantly ferric iron-rich subsurface reservoir where H₂S, CO₂, and/or SO₂ are mineralized to solids producing CO₂-free hydrogen gas.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In view of the foregoing, one objective of the present disclosure is to provide a method for producing carbon-free hydrogen. A second objective of the present disclosure is to provide a system for producing carbon-free hydrogen. The method and system of the present disclosure utilize naturally occurring in-situ geological formations to enable subsurface carbon-free hydrogen production, facilitating the extraction and use of hydrogen. This approach contrasts with conventional surface-based sulfur removal processes such as the Claus process for removing H₂S, and the different desulphurization processes for removing SO₂, which are energy-intensive. Additionally, the method and system of the present disclosure can be applied in subsurface reservoirs that contain both ferric and ferrous iron-rich minerals, enabling the economic disposal of hazardous H₂S waste, with or without the accompanying carbon dioxide and/or sulfur dioxide, in an environmentally responsible manner.

Provided in this disclosure are methods and systems for producing carbon-free hydrogen via in-situ reactions between H₂S-bearing fluid streams, such as sulfur waste gases, and geological minerals rich in oxidized (ferric) iron that may be distributed in sedimentary, igneous, or metamorphic geological formations. The ferric iron present in an iron-rich subsurface reservoir of the subsurface geological formation can effectively fix the sulfur present in a H₂S-bearing fluid stream through in-situ mineralization to iron sulfide while liberating hydrogen gas (H₂) as product. The hydrogen gas will accumulate in the same reservoir in which the H₂S and/or H₂S mineralization has occurred and can thus be produced as a natural hydrogen gas stream. The sulfur remains sequestered in the iron-rich subsurface reservoir as harmless and common sulfide minerals, such as pyrite (FeS₂). In some embodiments, the geological formation may contain minerals rich in ferrous (reduced) iron, which are also reactive with H₂S-bearing compounds, such as H₂S. In some embodiments, the H₂S-bearing fluid stream further contains one or more of CO₂, and/or SO₂. The CO₂ is converted to iron carbonates, such as siderite (FeCO₃) and/or ankerite Ca(Fe,Mg,Mn)(CO₃)₂ in the iron-rich subsurface reservoir, thereby facilitating the release of additional hydrogen through the process described in this disclosure.

In some embodiments, the iron-rich subsurface reservoir is a subsurface porous reservoir (layer) that can withhold the H₂S containing fluid stream. The H₂S-bearing fluid stream, such as a H₂S-bearing fluid stream, reacts with the ferric iron within pore spaces and voids of the iron-rich subsurface reservoir. In such cases, the system for producing carbon-free hydrogen also includes surrounding rocks and a cap rock seal overlaying the iron-rich subsurface reservoir. The surrounding rocks and the cap rock seal may be impermeable rock or low-permeable rock, such as low-permeability geological strata. In this way, the cap rock seal and the surrounding rocks may trap or otherwise prevent fluids in the iron-rich subsurface reservoir from migrating out of the system to a lesser depth, a greater depth, or approximately same depth of the surrounding geological formations.

In some embodiments, the iron-rich subsurface reservoir is a subsurface low porosity layer (reservoir) that prevents the H₂S-bearing fluid stream flowing into surrounding geological formations. In such case, the iron-rich subsurface reservoir possesses fracture-based permeability in natural fault and fracture networks. The H₂S-bearing fluid stream containing H₂S and/or SO₂, reacts with the ferric iron within pore spaces and voids of the iron-rich subsurface reservoir, as well as the natural fault and fracture networks of the system.

In some embodiments, the iron-rich subsurface reservoir is impermeable or nonporous. In such cases, the H₂S-bearing fluid stream reacts with the ferric iron within the natural fault and fracture networks of the system.

In some embodiments, the iron-rich subsurface reservoir contains ferric iron (Fe³⁺) rich minerals and/or ferric and ferrous iron rich minerals including, but not limited to, iron oxides such as magnetite (Fe₃O₄) and hematite (Fe₂O₃), iron hydroxides such as goethite (FeO(OH)), iron-rich silicates such as amphibole K,Fe₃AlSi₃O₁₀(OH)₂, glauconite ((K,Na)(Fe,Al,Mg)₂(Si,Al)₄O₁₀(OH)₂), and iron-chlorite ((Mg,Fe)₃(Si,Al)₄O₁₀(OH)₂(Mg,Fe)₃(OH)₆). Reservoirs rich in such iron minerals can be located via common geological exploration methods. In some embodiments, a H₂S-bearing fluid storage unit, such as a H₂S and/or SO₂ bearing fluid storage unit containing a H₂S and/or SO₂-bearing fluid stream, is a subsurface storage reservoir or a surface storage tank. In further embodiments, the H₂S-bearing fluid storage unit, such as a H₂S and/or SO₂-bearing fluid storage unit, is a subsurface storage reservoir in direct fluid communication with the iron-rich subsurface reservoir. In one example, the iron-rich subsurface reservoir is in the strata positioned uphole and adjacent to the subsurface storage reservoir. In one example, the iron-rich subsurface reservoir is in the strata positioned downhole and adjacent to the subsurface storage reservoir. In another example, the iron-rich subsurface reservoir is in the strata positioned at approximately the same depth and adjacent to the subsurface storage reservoir. Wells (e.g., crossflow wells) and/or surface pipelines allow flow of the H₂S-bearing fluid steam, such as a H₂S and/or SO₂-bearing fluid stream, from the subsurface storage reservoir to the iron-rich subsurface reservoir.

In some embodiments, the H₂S-bearing fluid storage unit, such as a H₂S and/or SO₂-bearing fluid storage unit, containing a H₂S-bearing fluid stream, such as a H₂S and/or SO₂ bearing fluid stream, is a surface storage tank. In some examples, the iron-rich subsurface reservoir may exist in an offset location that is away from the surface storage tank, such that the iron-rich subsurface reservoir and the surface storage tank are laterally separated but connected entirely in the subsurface. In such cases, surface pipework or transport may be required to allow flow of H₂S-bearing fluid stream, such as a sulfur waste, from the surface storage tank to the iron-rich subsurface reservoir.

In the iron-rich subsurface reservoir, sulfur is removed from the H₂S-bearing fluid stream, thereby generating a sweet fluid stream having a reduced-sulfur content as compared to the H₂S-bearing fluid stream, liberating H₂ while the sulfur is mineralized as an iron scale, such as pyrite. The sweet fluid stream and hydrogen so produced can then be flowed to surface by conventional production wells and any supporting engineering such as pressure support mechanisms. The subsurface geological formations of the present disclosure can be accommodated by existing drilling engineering and subsurface exploration, production and monitoring technologies including four-dimensional space (4D) seismic.

In the present disclosure, chemical reactions occur in sedimentary, igneous and metamorphic geology where Fe-bearing minerals containing ferric iron may react with the injected H₂S-bearing fluid stream, such as a sulfur waste gas. Equation 1 below describes the general reaction that removes H₂S from the H₂S-bearing fluid stream by the reaction of H₂S with the Fe³⁺ mineral hematite (Fe₂O₃) as of result of which, H₂S is mineralized to pyrite with the simultaneous production of carbon-free hydrogen.

$$4 {H}_{2} S + {Fe}_{2} {O}_{3} = 2 Fe {S}_{2} + 3 {H}_{2} O + {H}_{2} \qquad Eq . 1$$

The reaction in Eq. 1 includes several steps. The first step is a reaction between Fe³⁺ and the sulfide ion HS⁻ (aq.) produced from the dissociation of H₂S in water/brine expressed in Equation 2.

$$8 {Fe}^{3 +} + {HS}^{-} + 4 {H}_{2} O = 8 {Fe}^{2 +} + {SO}_{4}^{2 -} + 9 {H}^{+} \qquad Eq . 2$$

During the above reaction, ferric iron Fe³⁺ is reduced to ferrous iron Fe²⁺, which reacts further with H₂S to produce hydrogen as per Equations 3 to 7.

$${Fe}^{2 +} + {HS}^{-} = FeS + {H}^{+} \qquad Eq . 3$$

$$2 FeS + 2 {H}^{+} = {FeS}_{2} + {Fe}^{2 +} + {H}_{2} \qquad Eq . 4$$

$$FeS + {H}_{2} S = {FeS}_{2} + {H}_{2} \qquad Eq . 5$$

H₂S is also removed from the H₂S-bearing fluid stream by reactions with ferric iron hydroxide minerals (or amorphous phases) including, but not limited to, ferrihydrite, lepidocrocite and goethite. Those reactions are described in Equations 7-8, where Fe³⁺ from the iron hydroxide is first reduced to Fe²⁺ in the form of iron monoxide (FeS) as per Equation 6 and then to pyrite (FeS₂) in further reactions as per Equations 4 and 5.

$${Fe ( OH )}_{2} + {HS}^{-} = FeS + {H}_{2} O \qquad Eq . 6$$

The remaining iron hydro oxide minerals (or amorphous phases) may react further with Fe²⁺ produced in reactions described in Equations 2 and 4 to produce magnetite (Fe₃O₄), an iron oxide that consists of equal parts ferric and ferrous iron, as per Equation 7.

$$2 {Fe ( OH )}_{2} + {Fe}^{2 +} = {Fe}_{3} {O}_{4} + 2 {H}_{2} O + 2 {H}^{+} \qquad Eq . 7$$

Further reactions of a H₂S-bearing fluid stream with magnetite (Fe₃O₄) will create hydrogen as described in Equation 8.

$${Fe}_{3} {O}_{4} + 6 {H}_{2} S = 3 Fe {S}_{2} + 4 {H}_{2} O + 2 {H}_{2} \qquad Eq . 8$$

In cases where sulfur is consumed, the remaining Fe²⁺ may react with water to produce additional hydrogen by a different type of common H₂ generating reaction known as water reduction reaction as described in Equation 9.

$$2 {Fe}_{3} {O}_{4} + {H}_{2} O = 2 {Fe}_{2} {O}_{3} + {H}_{2} \qquad Eq . 9$$

In some embodiments, the H₂S-bearing fluid stream further contains one or more components selected from the group consisting of carbon dioxide (CO₂), sulfur dioxide (SO₂), water, brine, one or more non-polar fluids such as natural and/or refined or synthetic hydrocarbons, and one or more additives. In some embodiments, the H₂S-bearing fluid stream further contains one or more of CO₂ and SO₂. In such cases, CO₂ mineralization occurs alongside the sulphidation of ferric iron minerals by H₂S and the associated production of H₂. In such cases, co-injection of CO₂ and H₂S into an iron-rich subsurface reservoir, such as a Fe³⁺ bearing sandstone, results in the mineralization of CO₂ to siderite (FeCO₃) as per Equation 10, which proceeds along with the H₂ producing reactions from Equations 2-5.

$${Fe}^{2 +} + {HCO}^{3 -} = {FeCO}_{3} + {H}^{+} \qquad Eq . 10$$

Having CO₂ as a part of a H₂S bearing stream is therefore advantageous/synergetic due to the release of additional protons (H⁺) for redox reactions such as Equation 4 thus contributing to the production of more H₂.

Furthermore, mineralization of CO₂ to carbonate in ferric iron-rich reservoirs may only proceed if H₂S is available. Ferric-iron lithologies including iron-rich sandstones are generally poor in Ca and/or Mg minerals (silicates), which limits the availability of Ca and/or Mg and hence mineralization of CO₂ to Ca and/or Mg carbonates (e.g., calcite, dolomite, magnesite). Ca and/or Mg carbonate formation is suppressed further by the comparatively low pH of the formation waters in such reservoirs. At the same time the very low aqueous solubility of ferric iron renders this form of iron practically unavailable to form iron carbonate. As demonstrated in Equation 2 however, the injection of a H₂S-bearing fluid stream in the ferric iron reservoir reduces this form of iron to its highly soluble reduced (ferrous) form, which then readily reacts with CO₂ to form iron carbonate (Equation 10).

In some embodiments, H₂S is added to a stream of supercritical CO₂ disposed of in Fe-rich sandstone in a conventional Carbon Capture and Storage (CCS) operation. In such cases, adding H₂S to the supercritical CO₂ enables and/or enhances the mineralization of CO₂ to iron carbonate. The related “loss” of CO₂ to mineralization abates reservoir pressure and de-risks the CCS operation not only by reducing long term monitoring of reservoir pressure but also by potentially preventing reservoir/seal damage from sustained high pressures.

In some embodiments, the fluid stream contains H₂S, CO₂ and SO₂. In such cases reactions of these compounds with ferric iron-include the reduction of Fe³⁺ to Fe²⁺ with H₂S (HS—) (Equations 2 and 6), dissociation of SO₂ to sulphuric acid and H₂S (Equation 11) followed by reduction of sulphuric acid to elemental sulphur (Equation 12) and pyrite (Equation 13).

$$4 {SO}_{2} + 4 {H}_{2} O = {H}_{2} S + 3 {H}_{2} S {O}_{4} \qquad Eq . 11$$

$$3 {H}_{2} S + {H}_{2} {SO}_{4} = 4 S + 4 {H}_{2} O \qquad Eq . 12$$

$${Fe}^{2 +} + {S}^{2 -} = FeS \qquad Eq . 13$$

The mineralization of SO₂ to iron monosulphide consumes H₂S and Fe²⁺ without producing H₂. The impact on the overall H₂ production is however insignificant due to the low (trace) concentrations of SO₂ commonly encountered in flue gases and the CO₂ separated from such gases. Additionally, the benefit of removing SO₂ from a H₂S—CO₂—SO₂-bearing stream outweighs any minor loss of H₂.

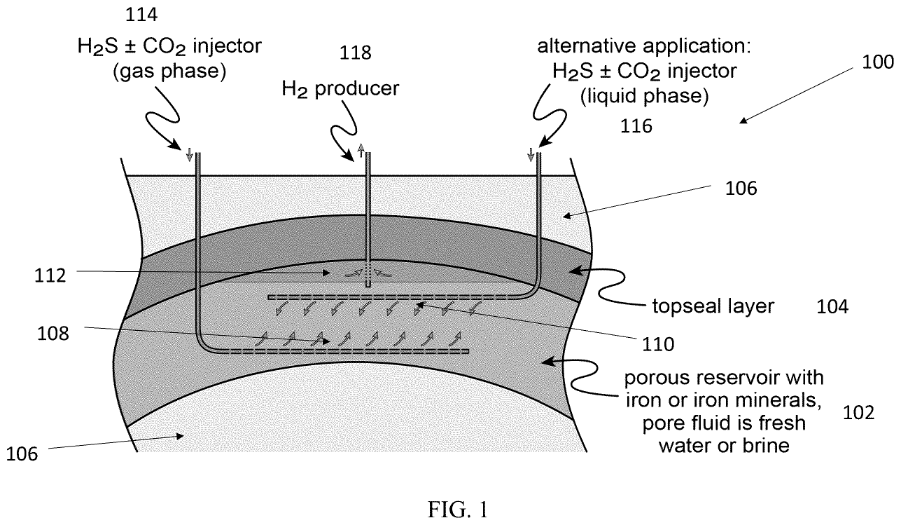

Therefore, the simultaneous removal of H₂S and CO₂ (with or without SO₂) by iron-rich formations does not affect the production of H₂ by either of the two principal reactions shown in Equations 1-9. The results demonstrate that the ratio of H₂S to CO₂ in the H₂S-bearing fluid stream has an impact on the precipitate of mineral phases (e.g., siderite and pyrite). In some embodiments, the H₂S is present in the H₂S-bearing fluid stream in an amount of more than about 15 wt. % based on a total weight of the H₂S-bearing fluid stream, such as more than about 20 wt. %, more than about 30 wt. %, more than about 40 wt. %, more than about 50 wt. %, more than about 60 wt. %, more than about 70 wt. %, more than about 80 wt. %, more than about 90 wt. %, or more than about 95 wt. %, based on the total weight of the H₂S-bearing fluid stream. In some embodiments, the CO₂ is present in the H₂S-bearing fluid stream in an amount of no more than about 15 wt. % based on the total weight of the H₂S-bearing fluid stream, such as no more than about 10 wt. %, no more than about 5 wt. %, or no more than about 1 wt. % based on the total weight of the H₂S-bearing fluid stream. Hydrocarbon fields are generally found in sedimentary basins, where the hydrocarbons mature from source rocks at depth then accumulate in porous reservoir layers such as sandstone or limestone inside the sedimentary basin. In the present disclosure, one or more subsurface sequestration locations containing sedimentary rocks such as sandstone may be identified, where the presence of ferric iron in minerals within a subsurface porous reservoir can be used as a filter and/or a scavenger to remove H₂S and/or CO₂ from the H₂S-bearing fluid stream as depicted in FIG. 1.

According to an aspect of the present disclosure, a method for producing carbon-free hydrogen includes identifying one or more geological formations including a cap rock seal and an iron-rich subsurface reservoir. The iron-rich subsurface reservoir contains one or more types of reactive iron-rich minerals containing ferric iron. Presence of ferrous iron bearing minerals in such reservoirs, while advantageous is not required because of H₂S's strong chemical reduction potential and its capability to rapidly convert Fe³⁺ to Fe²⁺, which reacts further with H₂S and/or H₂O to generate hydrogen. Moreover, the ferric iron and/or ferrous iron are in one or more crystalline and/or amorphous phases. Any method of subsurface mapping that may be standard in, for example, the fields of oil and gas exploration, may be used to identify subsurface geological structures that may include the associated sequestration locations. In some embodiments, the mapping is performed by reflection seismic mapping, which uses 2-dimensional reflection seismic data and/or 3-dimensional reflection seismic data, to form a subsurface map of the area under study. Reflection seismic data mapping may be augmented (also referred to as “ground truthed”) by drilled wells (also referred to as “subterranean bores”) to ensure the accuracy of depth on these maps and confirm the presence of reactive iron-minerals. In some embodiments, maps are constructed from well data alone when a sufficient number of such wells are drilled into the area under study. It may also be possible to use potential field data, such as gravity data, magnetism, or both gravity data and magnetism, to identify iron-rich subsurface geological structures. In some embodiments, more than one method of identifying the one or more geological formations containing the iron-rich subsurface reservoir is used. In some embodiments, the iron-rich subsurface reservoir has a temperature of about 10 to about 500° C., such as about 50 to about 450° C., about 100 to about 500° C., about 150 to about 450° C., about 200 to about 400° C., about 250 to about 350° C., or about 300° C. In some embodiments, when the H₂S-bearing fluid stream contains CO₂, the iron-rich subsurface reservoir has a temperature of about 10 to about 350° C., such as about 50 to about 300° C., about 100 to about 250° C., about 150 to about 200° C., or about 175° C. In some embodiments, the iron-rich subsurface reservoir has a pressure of about 100 to about 60,000 kilopascals (kPa), such as about 1000 to about 50,000 kPa, about 10,000 to about 40,000 kPa, about 20,000 to about 30,000 kPa, or about 25,000 kPa.

The method for producing carbon-free hydrogen also includes introducing a hydrogen sulfide (H₂S)-containing fluid stream into the geological formation containing the iron-rich subsurface reservoir and the cap rock seal. In some embodiments, the geometric structure of the iron-rich subsurface reservoir is selected from the group consisting of a horizontal structure, an inclined structure, a planar structure, a folded structure, and a faulted structure. In further embodiments, the iron-rich subsurface reservoir is a horizontal structure. In some embodiments, the H₂S-bearing fluid stream is in gas form, and is introduced upwardly from a H₂S-bearing fluid storage unit to a bottom portion of the iron-rich subsurface reservoir. In some embodiments, the H₂S-bearing fluid stream is in liquid or supercritical fluid form, and is introduced downwardly from the H₂S-bearing fluid storage unit to an upper portion of the iron-rich subsurface reservoir. In some embodiments, the H₂S-bearing fluid stream, is in liquid, gas, or supercritical fluid form, and the stream is introduced from any position of the iron-rich subsurface reservoir. In some embodiments, the H₂S-bearing fluid stream is in supercritical fluid form. In such cases, the H₂S-bearing fluid stream is formed by introducing H₂S into a supercritical CO₂ stream before introducing the H₂S-bearing fluid stream into the iron-rich subsurface reservoir.

In some embodiments, the H₂S-bearing fluid stream further contains one or more components selected from the group consisting of water, brine, one or more gases, one or more hydrocarbons, and one or more additives. In some embodiments, the one or more gases are selected from the group consisting of carbon dioxide (CO₂) and sulfur dioxide (SO₂). In some embodiments, the H₂S-bearing fluid stream contains one or more of CO₂ and SO₂. In further embodiments, the H₂S-bearing fluid stream contains H₂S and CO₂. In further embodiments, the H₂S-bearing fluid stream contains H₂S. In some embodiments, the H₂S-bearing fluid stream is a supercritical gas containing H₂S, CO₂, and/or SO₂.

In some embodiments, the one or more hydrocarbons include hydrocarbon liquids as well as hydrocarbon gases. In some embodiments, the hydrocarbon liquids are petroleum-based hydrocarbons. The petroleum-based hydrocarbons may be from any source of petroleum-based hydrocarbons. Examples of sources of petroleum-based hydrocarbons include whole crude oil, condensate, distilled crude oil, atmospheric distillate oil, atmospheric residue stream, vacuum distillate oil, vacuum residue stream, pyrolysis product streams (such as light cycle oil and coker gas oil), decant oil, oils containing hydrocarbons having 10 or more carbon atoms (C10+ oil), and other streams of hydrocarbons derived from ethylene plants, liquefied coal, and biomass sources. The source of the petroleum-based hydrocarbons may be a single stream from a refinery or a combined stream from a refinery. The source of the petroleum-based hydrocarbons may be from upstream operations, such as the produced oil stream. The hydrocarbon gases are light hydrocarbon gases selected from the group consisting of methane, ethane, and propane.

In some embodiments, the one or more additives include biocides and/or chemical inhibitors. The introduction and presence of these biocides and chemical inhibitors in the iron-rich subsurface reservoir can effectively inhibit the regeneration of H₂S in the iron-rich subsurface reservoir by inhibiting the sulfate-reducing activity of sulfate-reducing bacteria (SRB) as well as reducing the consumption of the hydrogen produced within the iron-rich subsurface reservoir. In some embodiments, the biocides are selected from the group consisting of glutaraldehyde and quaternary ammonium compounds. In some embodiments, the chemical inhibitors are selected from the group consisting of nitrate compounds, phosphate compounds, corrosion inhibitors, heavy metals, and acidic inhibitors.

In some embodiments, the H₂S-bearing fluid stream contains aqueous fluid(s) such as water and brine. The water is generally denser than the one or more hydrocarbons. As a result, the one or more hydrocarbons of the H₂S-bearing fluid stream may accumulate as a positively buoyant fluid in an upper region of the iron-rich subsurface reservoir, as illustrated in FIG. 1. The relatively denser water present in a water zone of the iron-rich subsurface reservoir may then accumulate underneath the one or more hydrocarbons, also as shown in FIG. 1. Furthermore, the one or more hydrocarbons may also be differentiated by a positively buoyant layer of hydrocarbon gases over the hydrocarbon liquids of the H₂S-bearing fluid stream.

In some embodiments, the iron-rich subsurface reservoir contains one or more types of reactive ferric iron-rich minerals in the form of crystalline phase and/or amorphous phase. In some embodiments, the one or more types of reactive ferric iron-rich minerals present in the iron-rich subsurface reservoir include, but are not limited to ferric iron bearing minerals such as ferric oxide, hematite, goethite, limonite, maghemite, ferric hydroxide, ferroxyhyte, ferrihydrite, akaganeite, lepidocrocite, schwertmannite, green rust, fougerite, jarosite, glauconite, iron chlorite.

In some embodiments, the iron-rich subsurface reservoir further contains one or more types of ferrous iron-rich minerals and one or more types of ferric iron and ferrous iron-rich minerals. In some embodiments, the one or more types of reactive ferrous iron-rich minerals present in the iron-rich subsurface reservoir include, but are not limited to, ferrous oxide, magnetite, ferrous hydroxide, glauconite, iron chlorite, siderite, olivine (fayalite), augite, hedenbergite, garnet (almandine), biotite, hornblende. In some embodiments, the one or more types of ferric iron and ferrous iron-rich minerals present in the iron-rich subsurface reservoir include, but are not limited to, ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, greigite, olivine (fayalite), augite, hedenbergite, biotite, hornblende, garnet (almandine), vivianite, jarosite, glauconite, iron chlorite, and native iron.

In further embodiments, the iron-rich subsurface reservoir contains one or more of hematite, magnetite, maghemite, goethite, glauconite, or iron chlorite, or combinations thereof. In some embodiments, the iron-rich subsurface reservoir contains glauconite. The glauconite mineral is deposited in marine sandstones that are known as “greensands” due to the color lent to the marine sandstones by the glauconite. In some embodiments, the iron-rich subsurface reservoir contains one or more of magnetite and hematite. The magnetite and hematite are deposited in marine sandstones that are known as “redbeds” due to the color lent to the marine sandstones. In further embodiments, the iron-rich subsurface reservoir contains one or more of ferrous iron-rich igneous and metamorphic rocks including, but not limited to, peridotite, basalt, gabbro, andesite, granite, and amphibolite.

In some embodiments, the iron-rich subsurface reservoir contains ferrous iron and ferric iron. A mass ratio of the ferric iron to the ferrous iron present in the iron-rich subsurface reservoir is about 1000:1 to about 1:1, such as about 950:1 to about 50:1, about 900:1 to about 100:1, about 850:1 to about 150:1, about 800:1 to about 200:1, about 750:1 to about 250:1, about 700:1 to about 300:1, about 650:1 to about 350:1, about 600:1 to about 400:1, about 550:1 to about 450:1, or about 500:1, about 400:1, about 300:1, about 200:1, or about 100:1. In some embodiments, the H₂S is present in the H₂S-bearing fluid stream in an amount of more than about 1000 parts per million (ppm) based on a total weight of the sour oil stream, such as more than about 10,000 ppm, more than about 50,000 ppm, more than about 100,000 ppm, more than about 150,000 ppm, more than about 200,000 ppm, more than about 250,000 ppm, more than about 300,000 ppm, more than about 350,000 ppm, or more than about 400,000 ppm based on the total weight of the sour oil stream. In some embodiments, the H₂S present in the H₂S-bearing fluid stream is introduced from a natural gas, a biomass conversion process, or a power plant. The H₂S present in the H₂S-bearing fluid stream is in both dissolved and/or undissolved form.

In some embodiments, the H₂S-bearing fluid stream is introduced into the iron-rich subsurface reservoir from a H₂S-bearing fluid storage unit. The H₂S-bearing fluid storage unit may be a subsurface storage reservoir or a surface storage tank. In further embodiments, the H₂S-bearing fluid storage unit is a geological subsurface storage reservoir. In some embodiments, the subsurface storage reservoir and the iron-rich subsurface reservoir are closely located to each other and are in direct fluid communication with each other via a reservoir connector well, or a crossflow well.

In some embodiments, the iron-rich subsurface reservoir is positioned uphole and adjacent to the subsurface storage reservoir. The H₂S-bearing fluid stream is introduced upwardly from the subsurface storage reservoir to the iron-rich subsurface reservoir. The subsurface storage reservoir and the iron-rich subsurface reservoir are separated by a low-permeability geological formation also known as a seal. In such cases, the subsurface storage reservoir is likely to have a higher pore fluid pressure than the iron-rich subsurface reservoir, thereby allowing the H₂S-bearing fluid stream to flow from the subsurface storage reservoir into the iron-rich subsurface reservoir in the absence of a pump to lift the H₂S-bearing fluid stream through a reservoir connector well, or a crossflow well. The co-location of the subsurface storage reservoir and the iron-rich subsurface reservoir minimizes transportation costs of the H₂S-bearing fluid stream and reduces environmental impacts of emissions and fluid leakage in transit. In further embodiments, the H₂S-bearing fluid storage unit is a surface storage tank. In some embodiments, the subsurface storage reservoir is in fluid communication with the iron-rich subsurface reservoir via an injection well. Injection wells can perform roles such as introducing sour water/brine, oil or gas from other locations, or injecting water to manage subsurface pressure in the iron-rich subsurface reservoir. Additionally, the injection wells can support fluid movement within the iron-rich subsurface reservoir.

In some embodiments, the iron-rich subsurface reservoir is positioned downhole and adjacent to the subsurface storage reservoir. The H₂S-bearing fluid stream is introduced downwardly from the subsurface storage reservoir to the iron-rich subsurface reservoir.

In some embodiments, the iron-rich subsurface reservoir is in the strata positioned at approximately the same depth and adjacent to the subsurface storage reservoir. Wells (e.g., crossflow wells) and/or surface pipelines allow flow of the H₂S-bearing fluid stream from the subsurface storage reservoir to the iron-rich subsurface reservoir.

In some embodiments, the subsurface storage reservoir and the iron-rich subsurface reservoir are distantly located from each other and cannot be connected via a reservoir connector well. In such cases, the H₂S-bearing fluid stream from the subsurface storage reservoir may be pumped laterally in a pipework system and reinjected at an appropriate location into the iron-rich subsurface reservoir. In some further embodiments, the H₂S-bearing fluid stream from the subsurface storage reservoir is pumped into a storage unit or loaded into a transport container of a vehicle and delivered to the iron-rich subsurface reservoir. In some embodiments, the vehicle includes, but is not limited to, a train, a truck, a van, a trailer, a semi-trailer, an articulated convoy, or a wagon. In some further embodiments, the iron-rich subsurface reservoir can form a project hub to which the H₂S-bearing fluid stream is transported from multiple surroundings or even distant sources.

Once introduced into the subsurface storage reservoir, the H₂S may be retained within the geological basin of the subsurface storage reservoir for long periods of time. That is, no measurable amount of H₂S may be released from the geological basin for at least 1 year, at least 5 years, at least 10 years, or at least 15 years, or longer. Of course, the H₂S may be retained with the geological basin for 100 years or more, for instance for 2000 years or more, for 3000 years or more, for 4000 years or more, or for 5000 years or more.

The method for producing carbon-free hydrogen further includes contacting the H₂S-bearing fluid stream with the one or more types of reactive iron-rich minerals present in the iron-rich subsurface reservoir, thereby generating a sweet oil stream, an iron scale, and a hydrogen gas cap. The sweet oil stream generated after the contacting of the H₂S-bearing fluid stream with the one or more types of reactive iron-rich minerals has a reduced H₂S content as compared to the H₂S-bearing fluid stream. Additionally, the iron scale is deposited within the iron-rich subsurface reservoir, and the hydrogen gas cap is formed in an upper portion of the iron-rich subsurface reservoir beneath a cap rock seal. When the H₂S-bearing fluid stream contains H₂S and CO₂, the one or more types of reactive iron-rich minerals may also react with CO₂ to generate iron carbonate (FeCO₃) scale deposited within the iron-rich subsurface reservoir. Therefore, carbon sequestration can also be achieved by the methods and systems of the present disclosure. In some embodiments, the iron scale contains an iron sulfide scale and an iron carbonate scale. In some embodiments, the iron sulfide scale contains at least one of pyrite, pyrrhotite, troilite, greigite, mackinawite, or marcasite. In further embodiments, the iron sulfide scale is pyrite. In some embodiments, the iron carbonate scale contains at least one of siderite or ankerite. In further embodiments, the iron carbonate scale is siderite. In some embodiments, the H₂S is present in the sweet fluid stream in an amount of less than about 4 ppm based on a total weight of the sweet fluid stream, such as less than about 3 ppm, less than about 2 ppm, or less than about 1 ppm based on the total weight of the sweet fluid stream.

The method for producing carbon-free hydrogen further includes flowing the sweet fluid stream into a sweet fluid storage unit via a sweet fluid production well, and flowing the hydrogen gas cap into a hydrogen storage unit via a hydrogen production well. In some embodiments, at least a portion or all of the hydrogen is dissolved in the sweet fluid stream and should be separated using appropriate plant at surface. In some embodiments, the iron-rich subsurface reservoir is in fluid communication with a water source via a water injection well. In some embodiments, the water source includes one or more of deionized, tap, distilled, or fresh waters; natural, brackish, or brine waters; marine waters, natural hydrocarbon formation produced waters, or synthetic brines; filtered or untreated seawaters; mineral waters; treated or untreated wastewater; or other potable or non-potable waters containing one or more dissolved salts, minerals, or organic materials. In some embodiments, the aqueous water source contains at least about 80 wt. %, such as at least about 90 wt. %, at least about 95 wt. %, at least about 99 wt. %, at least about 99.9 wt. % or at least about 100 wt. % of water. In some embodiments, at least about 90 wt. %, at least about 95 wt. %, or at least about 99 wt. % of the water source by mass can be a brine solution. In some embodiments, the brine solution has a density of about 1.03 to about 1.2 g/mL, such as about 1.03 to about 1.15 g/mL, about 1.03 to about 1.1 g/mL, about 1.03 to about 1.05 g/mL, about 1.05 to about 1.2 g/mL, about 1.1 to about 1.2 g/ml, or about 1.15 to about 1.2 g/mL. In some embodiments, the density of the H₂S-bearing fluid stream present in the iron-rich subsurface reservoir is about 10% to 50% less than the density of the brine solution, such as about 15% to about 40% less, about 20% to about 30% less, or about 25% less.

In some embodiments, the water source is positioned within the subsurface geological formations. In some embodiments, the water source originates from the same zone within the subsurface geological formation in which the iron-rich subsurface reservoir is located. Without intending to be bound by any particular theory, it is believed that if the water source originates within the same zone within the subsurface geological formation, it can reduce potential incompatibility issues such as scaling that could interfere with the injectivity of the H₂S-bearing fluid. Further, it is believed that sourcing the water source from the subsurface geological formation can prevent reservoir overpressure and/or undesired fluid migration out of the injection zone. Additionally, it is believed that sourcing the water source from the subsurface geological formation can improve monitoring of gas sequestration and hydrogen production in the iron-rich subsurface reservoir.

The method for producing carbon-free hydrogen further includes monitoring a concentration of the iron scale in the iron-rich subsurface reservoir, and in response to the concentration of the iron scale exceeding a threshold concentration, stopping the introduction of the H₂S-bearing fluid stream from the H₂S-bearing fluid storage unit into the iron-rich subsurface reservoir. In some embodiments, the iron scale includes an iron sulfide scale and/or an iron carbonate scale. In further embodiments, the iron scale includes an iron sulfide scale. In some embodiments, the iron scale contains pyrite and siderite. In some embodiments, the concentration of the iron sulfide scale present in the iron-rich subsurface reservoir is obtained by a surface-based remote sensing technique selected from the group consisting of a four-dimensional (4D) reflection seismic survey technique, a gravity survey technique, a magnetic survey technique, and a magnetotellurics survey technique. In further embodiments, the concentration of the iron sulfide scale is determined by a 4D seismic survey technique.

According to an aspect of the present disclosure, a system (100) for producing carbon-free hydrogen is provided. Although the figures and discussion imply a two-dimensional or cross-section of the subsurface reservoirs and/or geological formations, in practice the subsurface reservoirs and/or the geological formations will be three-dimensional.

FIG. 1 illustrates a subsurface geological formation, where the subsurface geological formation includes an iron-rich subsurface reservoir (102), a cap rock seal (104), and surrounding rocks (106) that are co-located within the same geological structure. In this case, the hydrogen production process can be entirely subsurface. Also referring to FIG. 1, the subsurface geological formation that may include the associated sequestration locations is first identified by the methods described in the present disclosure. The iron-rich subsurface reservoir (102) contains a H₂S-bearing fluid stream in liquid, gas, or supercritical fluid form (108 and/or 110).

The iron-rich subsurface reservoir (102) contains one or more types of reactive iron-rich minerals. In some embodiments, the one or more types of reactive iron-rich minerals include, but are not limited to, ferrous oxide, ferric oxide, hematite, magnetite, goethite, limonite, maghemite, ferrous hydroxide, ferric hydroxide, ferroxyhyte, ferrihydrite, siderite, akaganeite, lepidocrocite, schwertmannite, green rust, fougerite, greigite, olivine (fayalite), augite, hedenbergite, biotite, hornblende, garnet (almandine), vivianite, jarosite, glauconite, iron chlorite, and native iron. In some embodiments, the one or more iron-rich minerals contain ferric iron and/or ferrous iron. The iron-rich subsurface reservoir (102) may be initially water-bearing or hydrocarbon bearing. In some embodiments, the iron-rich subsurface reservoir (102) is initially water-bearing as is normally the case where subsurface reservoirs or aquifers are not hydrocarbon bearing. In some examples, the pore spaces and voids of the iron-rich subsurface reservoir (102) contain only air with no liquid present. In further examples, the pore spaces and voids of the iron-rich subsurface reservoir (102) contain air and liquid before the introduction of the H₂S-bearing fluid stream. In further embodiments, the rich subsurface reservoir (102) contains natural fault and fracture networks.

The aqueous fluid residing in the iron-rich subsurface reservoir (102) may have a dissolved solids (TDS) content of less than about 300,000 ppm, such as less than about 200,000 ppm, less than about 100,000 ppm, less than about 50,000 ppm, less than about 10,000 ppm, less than about 5,000 ppm, or less than about 1,000 ppm. The iron-rich subsurface reservoir (102) also contains negligible amounts of H₂ consuming minerals including, but not limited to, manganese (Mn) oxides, hydroxides, carbonates, sulphates (gypsum/anhydrite), alkaline silicate minerals, labile organic matter, and/or hydrocarbons. The iron-rich subsurface reservoir (102) has a sulphate (SO₄²⁻) content of less than about 100 ppm, such as less than about 50 ppm, less than about 30 ppm, less than about 10 ppm, or less than about 1 ppm, as sulphate will react with and consume the hydrogen produced by the method of the present disclosure. In one embodiment, initial fluid pressure in the iron-rich subsurface reservoir (102) is normal, hydrostatic pressure which makes the iron-rich subsurface reservoir (102) a natural pressure sink for a higher-pressured fluid. In case of the iron-rich subsurface reservoir (102) being at greater than normal pressure (overpressured), it may still be applicable to use it when the H₂S-bearing fluid stream is overpressured by at least the same amount when introduced into the iron-rich subsurface reservoir (102). Overpressure in the H₂S-bearing fluid stream may occur naturally, or may be induced by one or more injection wells (114 and 116).

In some embodiments, the subsurface geological formation contains surrounding rocks (106) that prevent upwards, downwards, and lateral leakage of fluids from the iron-rich subsurface reservoir (102). As a result, a H₂S-bearing fluid stream in gas form (108) is introduced from a H₂S-bearing fluid storage unit into the iron-rich subsurface reservoir (102) via a first sour fluid injection well (114) from a bottom portion of the iron-rich subsurface reservoir (102). The H₂S-bearing fluid stream in gas form (108) has a higher pressure than fluids in the iron-rich subsurface reservoir (102). In some embodiments, a H₂S-bearing fluid stream in liquid or supercritical fluid form (110) is introduced from a H₂S-bearing fluid storage unit into the iron-rich subsurface reservoir (102) via a second sour fluid injection well (116) from an upper portion of the iron-rich subsurface reservoir (102). The H₂S-bearing fluid stream in liquid or supercritical fluid form (110) may have a substantial similar or higher pressure than fluids in the iron-rich subsurface reservoir (102). Therefore, the H₂S-bearing fluid stream in gas form (108) will migrate from the bottom portion to the upper portion of the iron-rich subsurface reservoir (102), and the H₂S-bearing fluid stream in liquid or supercritical fluid form (110) will migrate from the upper portion to the bottom portion of the iron-rich subsurface reservoir (102), but both not be able to pass through the surrounding rocks (106) and the cap rock seal (104), such that the H₂S-bearing fluid stream (108 and/or 110) is treated in the iron-rich subsurface reservoir (102) for simultaneous fluid sweetening and carbon-free hydrogen production. The surrounding rocks (106) may be impermeable rock or low-permeable rock, such as low-permeability geological strata. In some embodiments, the system (100) also includes the cap rock seal (104) overlying the iron-rich subsurface reservoir (102). The cap rock seal (104) may be impermeable rock that prevents vertical migration of fluids within the iron-rich subsurface reservoir (102) out of the system (100) in the upwards direction. In this way, the cap rock seal (104) and the surrounding rocks (106) may trap or otherwise prevent fluids in the iron-rich subsurface reservoir (102) from migrating out of the system (100) to a lesser depth, a greater depth, or approximately same depth.

Also referring to FIG. 1, the system (100) further includes one or more sour fluid injections wells (114 and/or 116), a sweet fluid production well (not shown), a water injection well (not shown), a hydrogen production well (118), and a surface-based remote sensing sensor (not shown). The one or more sour fluid injections wells (114 and/or 116) are configured to flow the H₂S-bearing fluid stream in different forms (108 and/or 110) from a H₂S-bearing fluid storage unit into the iron-rich subsurface reservoir (102). In some embodiments, the H₂S-bearing fluid storage unit is in the form of a reservoir located downhole and beneath the iron-rich subsurface reservoir (102). In such cases the H₂S-bearing fluid storage unit in the form of a reservoir is in fluid communication with the iron-rich subsurface reservoir (102) through a reservoir connector well (not shown). In some embodiments, the reservoir connector well may have a control line equipped with a pump installed between the two reservoirs. The pump is configured to lift the H₂S-bearing fluid stream in different forms (108 and/or 110) to the iron-rich subsurface reservoir (102). In some embodiments, the pump is an electric submersible pump.

In some embodiments, the iron-rich subsurface reservoir (102) contains one or more types of reactive ferric iron-rich minerals configured to react the H₂S and/or CO₂ in the H₂S-bearing fluid stream (108 and/or 110) with the one or more types of reactive ferric iron-rich minerals to generate a sweet fluid stream having a reduced-H₂S content as compared to the H₂S-bearing fluid stream (108 and/or 110), an iron scale deposited within the iron-rich subsurface reservoir (102), and a hydrogen gas cap (112) in an upper portion of the iron-rich subsurface reservoir (102) beneath the cap rock seal (104). When the H₂S-containing fluid stream consists of H₂S, the products of the reactions inside the iron bearing reservoir includes a sulfide scale and H₂. When the H₂S-bearing fluid stream (108 and/or 110) further contains CO₂, an iron carbonate (FeCO₃) scale is also generated within the iron-rich subsurface reservoir (102) due to the reaction of CO₂ with the one or more types of reactive ferric iron-rich minerals in the iron-rich subsurface reservoir (102). In some embodiments, the system (100) also includes a sweet oil production well configured to flow the sweet fluid stream, a hydrogen production well (118) configured to flow the hydrogen gas cap (112), a water injection well (not shown) configured to flow water into the iron-rich subsurface reservoir (102), and a surface-based remote sensing sensor. In some embodiments, the surface-based remote sensing sensor is configured to measure and monitor a concentration of the iron scale including, but not limited to, iron sulfide scale and iron carbonate scale, in iron-rich subsurface reservoir (102). In some embodiments, the iron scale contains pyrite and/or siderite. Pyrite is deposited within the iron-rich subsurface reservoir (102) as the H₂S is removed from the H₂S-bearing fluid stream (108 and/or 110). Pyrite may replace the one or more types of reactive ferric iron-rich minerals rather than occluding the porosity and permeability of the iron-rich subsurface reservoir (102). The density of pyrite is about 5 g/mL, which is greater than that of common reservoir-forming minerals such as quartz and carbonate, yet comparable to that of the one or more types of reactive ferric iron-rich minerals such as magnetite and hematite, which is about 5.2 g/mL. The density of pyrite is also greater than the density of iron hydroxides such as goethite, which is about 3.3 to about 4.3 g/mL. In cases of Fe hydroxides being the primary Fe-donors in the iron-rich subsurface reservoir (102), their replacement with pyrite may increase the bulk density and magnetic properties of the iron-rich subsurface reservoir (102), enabling the application of surface-based remote sensing techniques to monitor the accumulation of pyrite and/or siderite in the iron-rich subsurface reservoir (102) through time. Such surface-based remote sensing techniques include, but are not limited to, a four-dimensional (4D) reflection seismic survey technique, a gravity survey technique, a magnetic survey technique, and a magnetotellurics survey technique. One or more of these techniques could be deployed on the land surface above the iron-rich subsurface reservoir (102) to provide a full and repeatable subsurface image. Tracking and monitoring the accumulation of pyrite and/or siderite through time will allow for decisions on the management of a large-scale filtration project such as location of ongoing injection and/or production wells.

Also referring to FIG. 1, the system (100) further includes a sweet fluid storage unit (not shown) in fluid communication with the iron-rich subsurface reservoir (102) via a sweet fluid production well, a hydrogen storage unit (not shown) in fluid communication with the iron-rich subsurface reservoir (102) via the hydrogen production well (118), a H₂S-bearing fluid storage unit (not shown) in fluid communication with the iron-rich subsurface reservoir (102) via the sour fluid injection well (114 and/or 116), and a water source (not shown) in fluid communication with the iron-rich subsurface reservoir (102) via a water injection well extending downhole a depth within a water zone of the iron-rich subsurface reservoir (102). A pressure support for the iron-rich subsurface reservoir (102) may be provided by the water injection well (now shown) in a water zone. Migration of fluids in the iron-rich subsurface reservoir (102) may be governed by a combination of the fluid buoyancy pressure, pressure gradient and concentration gradient associated with the pressure and concentration of H₂S in the fluids at the point of injection into the iron-rich subsurface reservoir (102), relative to the initial (or far-field) iron-rich subsurface reservoir pore fluid pressure. In further embodiments, migration of the H₂S-bearing fluid stream in liquid and/or supercritical fluid form (110) in the iron-rich subsurface reservoir (102) can be further controlled by the water injection well (not shown), which is drilled and completed in appropriate locations within the iron-rich subsurface reservoir (102). The water injection well (not shown) allows liquid and/or supercritical fluids to flow not only from the H₂S-bearing fluid storage unit (116) to the iron-rich subsurface reservoir (102), but also supports lateral movement of liquid and/or supercritical fluids within the iron-rich subsurface reservoir (102) from the point of injection (e.g., an upper portion) to the point of production (e.g., the hydrogen production well (118)).

The locations of the sweet fluid production wells (not shown) used to extract a sweet fluid stream (not shown) containing the sweetened fluids can be selected laterally away from the injection points. As the fluids flow within the iron-rich subsurface reservoir (102) from injection to production wells, exposure of H₂S to the ferrous and/or ferric minerals in the iron-rich subsurface reservoir (102) allows the H₂S-fixing reaction to occur as depicted in Equations 1 to 15, as the H₂S-bearing fluid stream (108 and/or 110) flows through the pore network.

The system (100) after carbon-free hydrogen production shows a depleted sour fluid field of an accumulated pyrite and/or siderite present in the iron-rich subsurface reservoir (102). The accumulated pyrite and/or siderite may replace the original one or more types of reactive ferric iron-rich minerals as depicted in FIG. 1. The system (100) after hydrogen production may be fully plugged downhole to ensure the reservoirs are permanently isolated from one another, returning the fluid dynamics of the sedimentary basin to the initial stage as depicted in FIG. 1.

Although only one iron-rich subsurface reservoir is discussed in this illustrative example, it will be understood by those of ordinary skill in the art that the system for hydrogen production may include any number of iron-rich subsurface reservoirs that can be combined to produce sweetened fluids and hydrogen. In some embodiments, the system includes two or more iron-rich subsurface reservoirs, such as two, three, four, five, six, seven, or eight iron-rich subsurface reservoir.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### EMBODIMENTS

Embodiment 1: A method for producing carbon-free hydrogen, the method comprising:
introducing a hydrogen sulfide (H₂S)-bearing fluid stream into a geological formation comprising an iron-rich subsurface reservoir and a cap rock seal, wherein the iron-rich subsurface reservoir predominantly comprises one or more types of reactive ferric iron-rich minerals;
contacting the H₂S-bearing fluid stream with the one or more types of reactive ferric iron-rich minerals present in the iron-rich subsurface reservoir, thereby generating a sweet fluid stream having a reduced-sulfur content as compared to the H₂S-bearing fluid stream and an iron scale deposited within the iron-rich subsurface reservoir and forming a hydrogen gas cap in an upper portion of the iron-rich subsurface reservoir beneath the cap rock seal; and
flowing the sweet fluid stream into a sweet fluid storage unit via a sweet fluid production well, and flowing the hydrogen gas cap into a hydrogen storage unit via a hydrogen production well.

Embodiment 2: The method of embodiment 1, wherein the one or more types of reactive ferric iron-rich minerals are in the form of crystalline phase and/or amorphous.

Embodiment 3: The method of embodiment 1 or 2, wherein the one or more types of reactive ferric iron-rich minerals are selected from the group consisting of ferric oxide, hematite, magnetite, goethite, limonite, maghemite, ferric hydroxide, ferroxyhyte, ferrihydrite, akaganeite, lepidocrocite, schwertmannite, green rust, fougerite, biotite, hornblende, jarosite, glauconite, and iron chlorite.

Embodiment 4: The method of any one of embodiments 1-3, wherein the iron-rich subsurface reservoir further comprises one or more types of ferrous iron-rich minerals and one or more types of ferric iron and ferrous iron-rich minerals.

Embodiment 5: The method of any one of embodiments 1-4, wherein the H₂S-bearing fluid stream further comprises one or more components selected from the group consisting of carbon dioxide (CO₂), sulfur dioxide (SO₂) water, brine, one or more hydrocarbons, and one or more additives.

Embodiment 6: The method of any one of embodiments 1-5, wherein the H₂S-bearing fluid stream is in liquid, gas, or supercritical fluid form.

Embodiment 7: The method of any one of embodiments 1-6, wherein the H₂S-bearing fluid stream comprises one or more of CO₂ and SO₂, and the iron scale comprises at least one of an iron sulfide scale or an iron carbonate scale.

Embodiment 8: The method of any one of embodiments 1-7, wherein the iron sulfide scale comprises at least one of pyrite, pyrrhotite, troilite, greigite, mackinawite, or marcasite.

Embodiment 9: The method of any one of embodiments 1-8, wherein the iron sulfide scale comprises pyrite.

Embodiment 10: The method of any one of embodiments 1-9, wherein the iron carbonate scale comprises at least one of siderite or ankerite.

Embodiment 11: The method of any one of embodiments 1-10, wherein the iron carbonate scale comprises siderite.

Embodiment 12: The method of any one of embodiments 1-11, wherein the iron-rich subsurface reservoir is in fluid communication with a H₂S-bearing fluid storage unit via a crossflow well.

Embodiment 13: The method of any one of embodiments 1-12, wherein the iron-rich subsurface reservoir is in fluid communication with a water source via a water injection well.

Embodiment 14: The method of any one of embodiments 1-13, wherein the iron-rich subsurface reservoir is in a geometric structure selected from the group consisting of a horizontal structure, an inclined structure, a planar structure, a folded structure, and a faulted structure.

Embodiment 15: The method of any one of embodiments 1-14, wherein the iron-rich subsurface reservoir is a porous reservoir that can hold the H₂S-bearing fluid stream within its pores and cavities, thereby preventing the H₂S-bearing fluid stream flowing into surrounding geological formations.

Embodiment 16: The method of any one of embodiments 1-15, further comprising:
monitoring a concentration of the iron scale in the iron-rich subsurface reservoir; and
in response to the concentration of the iron scale exceeding a threshold concentration, stopping the introduction of the H₂S-bearing fluid stream from a H₂S-bearing fluid storage unit into the iron-rich subsurface reservoir.

Embodiment 17: The method of any one of embodiments 1-16, wherein the concentration of the iron sulfide scale present in the filtration reservoir is obtained by a surface-based remote sensing technique selected from the group consisting of a four-dimensional (4D) reflection seismic survey technique, a gravity survey technique, a magnetic survey technique, and a magnetotellurics survey technique.

Embodiment 18: The method of any one of embodiments 1-17, wherein the H₂S-bearing fluid storage unit is a subsurface reservoir and is in fluid communication with the iron-rich subsurface reservoir via a crossflow well.

Embodiment 19: The method of any one of embodiments 1-18, wherein the iron scale comprises pyrite.

Embodiment 20: The method of any one of embodiments 1-19, wherein the H₂S-bearing fluid stream is formed by introducing H₂S into a supercritical CO₂ stream before the introducing the H₂S-bearing fluid stream into the iron-rich subsurface reservoir.

Embodiment 21: A system for producing carbon-free hydrogen, the system comprising:
a sour fluid injection well configured to flow a H₂S-bearing fluid stream into the system;
a geological formation comprising an iron-rich subsurface reservoir and a cap rock seal, wherein the iron-rich subsurface reservoir predominantly comprises one or more types of reactive ferric iron-rich minerals that are capable of reacting the H₂S-bearing fluid stream with the one or more types of reactive ferric iron-rich minerals to generate a sweet fluid stream having a reduced-sulfur content as compared to the H₂S-bearing fluid stream, an iron scale deposited within the iron-rich subsurface reservoir, and a hydrogen gas cap in an upper portion of the iron-rich subsurface reservoir beneath the cap rock seal;
a sweet fluid production well configured to flow the sweet fluid stream;
a hydrogen production well configured to flow the hydrogen gas cap;
a water injection well configured to flow water into the iron-rich subsurface reservoir, thereby supporting fluid movement within the iron-rich subsurface reservoir; and
a surface-based remote sensing sensor configured to measure and monitor a concentration of the iron scale in the iron-rich subsurface reservoir.

Embodiment 22: The system of embodiment 21, wherein the system further comprises:
a sweet fluid storage unit in fluid communication with the iron-rich subsurface reservoir via the sweet fluid production well;
a hydrogen storage unit in fluid communication with the iron-rich subsurface reservoir via the hydrogen production well;
a H₂S-bearing fluid storage unit in fluid communication with the iron-rich subsurface reservoir via the sour fluid injection well; and
a water source in fluid communication with the iron-rich subsurface reservoir via the water injection well.

1. A method for producing carbon-free hydrogen, the method comprising:
introducing a hydrogen sulfide (H₂S)-bearing fluid stream into a geological formation comprising an iron-rich subsurface reservoir and a cap rock seal, wherein the iron-rich subsurface reservoir predominantly comprises one or more types of reactive ferric iron-rich minerals;
contacting the H₂S-bearing fluid stream with the one or more types of reactive ferric iron-rich minerals present in the iron-rich subsurface reservoir, thereby generating a sweet fluid stream having a reduced-sulfur content as compared to the H₂S-bearing fluid stream and an iron scale deposited within the iron-rich subsurface reservoir and forming a hydrogen gas cap in an upper portion of the iron-rich subsurface reservoir beneath the cap rock seal; and
flowing the sweet fluid stream into a sweet fluid storage unit via a sweet fluid production well, and flowing the hydrogen gas cap into a hydrogen storage unit via a hydrogen production well.

2. The method of claim 1, wherein the one or more types of reactive ferric iron-rich minerals are in the form of crystalline phase and/or amorphous.

3. The method of claim 1, wherein the one or more types of reactive ferric iron-rich minerals are selected from the group consisting of ferric oxide, hematite, magnetite, goethite, limonite, maghemite, ferric hydroxide, ferroxyhyte, ferrihydrite, akaganeite, lepidocrocite, schwertmannite, green rust, fougerite, biotite, hornblende, jarosite, glauconite, and iron chlorite.

4. The method of claim 1, wherein the iron-rich subsurface reservoir further comprises one or more types of ferrous iron-rich minerals and one or more types of ferric iron and ferrous iron-rich minerals.

5. The method of claim 1, wherein the H₂S-bearing fluid stream further comprises one or more components selected from the group consisting of carbon dioxide (CO₂), sulfur dioxide (SO₂) water, brine, one or more hydrocarbons, and one or more additives.

6. The method of claim 1, wherein the H₂S-bearing fluid stream is in liquid, gas, or supercritical fluid form.

7. The method of claim 1, wherein the H₂S-bearing fluid stream comprises one or more of CO₂ and SO₂, and the iron scale comprises at least one of an iron sulfide scale or an iron carbonate scale.

8. The method of claim 7, wherein the iron sulfide scale comprises at least one of pyrite, pyrrhotite, troilite, greigite, mackinawite, or marcasite.

9. The method of claim 7, wherein the iron sulfide scale comprises pyrite.

10. The method of claim 7, wherein the iron carbonate scale comprises at least one of siderite or ankerite.

11. The method of claim 7, wherein the iron carbonate scale comprises siderite.

12. The method of claim 1, wherein the iron-rich subsurface reservoir is in fluid communication with a H₂S-bearing fluid storage unit via a crossflow well.

13. The method of claim 1, wherein the iron-rich subsurface reservoir is in fluid communication with a water source via a water injection well.

14. The method of claim 1, wherein the iron-rich subsurface reservoir is in a geometric structure selected from the group consisting of a horizontal structure, an inclined structure, a planar structure, a folded structure, and a faulted structure.

15. The method of claim 1, wherein the iron-rich subsurface reservoir is a porous reservoir that can hold the H₂S-bearing fluid stream within its pores and cavities, thereby preventing the H₂S-bearing fluid stream flowing into surrounding geological formations.

16. The method of claim 1, further comprising:
monitoring a concentration of the iron sulfide scale in the iron-rich subsurface reservoir; and
in response to the concentration of the iron sulfide scale exceeding a threshold concentration, stopping the introduction of the H₂S-bearing fluid stream from a H₂S-bearing fluid storage unit into the iron-rich subsurface reservoir.

17. The method of claim 16, wherein the concentration of the iron sulfide scale present in the filtration reservoir is obtained by a surface-based remote sensing technique selected from the group consisting of a four-dimensional (4D) reflection seismic survey technique, a gravity survey technique, a magnetic survey technique, and a magnetotellurics survey technique.

18. The method of claim 16, wherein the H₂S-bearing fluid storage unit is a subsurface reservoir and is in fluid communication with the iron-rich subsurface reservoir via a crossflow well.

19. The method of claim 15, wherein the iron sulfide scale comprises pyrite.

20. The method of claim 1, wherein the H₂S-bearing fluid is formed stream by introducing H₂S into a supercritical CO₂ stream before the introducing the H₂S-bearing fluid stream into the iron-rich subsurface reservoir.

21. A system for producing carbon-free hydrogen, the system comprising:
a sour fluid injection well configured to flow a H₂S-bearing fluid stream into the system;
a geological formation comprising an iron-rich subsurface reservoir and a cap rock seal, wherein the iron-rich subsurface reservoir predominantly comprises one or more types of reactive ferric iron-rich minerals that are capable of reacting the H₂S-bearing fluid stream with the one or more types of reactive ferric iron-rich minerals to generate a sweet fluid stream having a reduced-sulfur content as compared to the H₂S-bearing fluid stream, an iron scale deposited within the iron-rich subsurface reservoir, and a hydrogen gas cap in an upper portion of the iron-rich subsurface reservoir beneath the cap rock seal;
a sweet fluid production well configured to flow the sweet fluid stream;
a hydrogen production well configured to flow the hydrogen gas cap;
a water injection well configured to flow water into the iron-rich subsurface reservoir, thereby supporting fluid movement within the iron-rich subsurface reservoir; and
a surface-based remote sensing sensor configured to measure and monitor a concentration of the iron scale in the iron-rich subsurface reservoir.

22. The system of claim 21, wherein the system further comprises:
a sweet fluid storage unit in fluid communication with the iron-rich subsurface reservoir via the sweet fluid production well;
a hydrogen storage unit in fluid communication with the iron-rich subsurface reservoir via the hydrogen production well;
a H₂S-bearing fluid storage unit in fluid communication with the iron-rich subsurface reservoir via the sour fluid injection well; and
a water source in fluid communication with the iron-rich subsurface reservoir via the water injection well.
